(19) United States
(12) Patent Application Publication
(10) Pub. No.: US 2025/0090976 A1
(43) Pub. Date: Mar. 20, 2025

(54) STREAMLINED EXTRACTION OF A CHEMICAL COMPOUND FROM PLANT MATTER THROUGH A FLEXIBLE EXTRACTION CONTAINER

(71) Applicant: Kristine Miller, Grants Pass, OR (US)

(72) Inventor: Kristine Miller, Grants Pass, OR (US)

(21) Appl. No.: 18/369,729

(22) Filed: Sep. 18, 2023

(51) Int. Cl. B01D 11/02

(52) U.S. Cl. CPC B01D 11/0257

(57) ABSTRACT

Disclosed is a method, a device, a system and/or a manufacture of streamlined extraction of a chemical compound from plant matter through a flexible extraction container. In one embodiment, an extraction container includes a base such that the extraction container can rest upright during an extraction. One or more walls comprised of the flexible polymer are coupled to the base to form an interior for the holding the plant matter and a solvent. The flexible polymer permits a user to knead the plant matter within the extraction container. A fastening mechanism fastens an opening and/or a lid in a closed position. A port is coupled to the lid and/or a wall enables elevated pressure to vent to the exterior environment. The strainer spans a portion of the one or more walls such that the chemical compound and the solvent can be separated from the plant matter following extraction.

### FIELD OF TECHNOLOGY

This disclosure relates generally to data processing devices and, more particularly, to a method, a device, and/or a system of streamlined extraction of a chemical compound from plant matter through a flexible extraction container.

### BACKGROUND

Chemical compounds have long been extracted from plants (including fungi) for a variety of uses, for example culinary use (e.g., flavors, spices, emulsifiers, colorings), craft use (dyes, building materials, treating agents), and medicinal use (e.g., medicines, treatments). An extraction is a process by which a substance, such as one or more chemical compounds, are separated from another substance, such as one or more other chemical compounds. For example, the extraction may extract one or more alkaloids (e.g., quinine and similar derivatives) from another substance (e.g., cinchona tree bark). Often, a solvent may be utilized to dissolve and/or carry the first substance, thus removing it from the second substance.

Various methods, devices, and/or systems may have been developed to effect extractions. Some of these methods, devices, and/or systems may result in cleaning and/or maintenance challenges, for example devices including complex parts or components. Other methods, devices, and/or systems may require specialized equipment, and/or the equipment may be limited to extraction of a small subset of chemical compounds. Some equipment may be relatively expensive to produce, limiting who can afford the equipment, perform the extraction, and/or limiting the scale of extraction. Other methods, devices, and/or systems may require specialized knowledge, skill, and/or training. This may similarly limit the environment in which the extraction can occur (e.g., generally reserved for laboratory, commercial, and/or industrial settings, rather than consumer, personal, and/or occurring in a residential environment). Still other methods, devices, and/or systems may use multiple components in a single extraction, for example where mastication of plant matter is required prior to application of a solvent, which may increase the time, complexity, cost and/or decrease yield of the extraction.

There is a continuing need for new methods, devices, and/or systems for efficiently, easily, and/or inexpensively. extracting chemical compounds, especially those that can aid in producing valuable chemical compounds usable in agriculture, cooking, crafting, medicine, and/or for other uses.

### SUMMARY

Disclosed are a method, a device, and/or a system of streamlined extraction of a chemical compound from plant matter through a flexible polymer extraction container.

In one embodiment, an extraction container for extracting a chemical compound with a solvent from a plant matter includes a base, one or more walls, a fastening mechanism, a port, and a strainer. The base is comprised of a flexible polymer and is flat such that the extraction container can rest upright during an extraction when the base is placed on a surface. The one or more walls are comprised of the flexible polymer and are coupled to the base to form both an interior of the extraction container for holding the plant matter and an opening at the top of the extraction container. The flexible polymer permits a user to knead the plant matter within the extraction container. The fastening mechanism is configured to fasten the opening in a closed position and/or fasten a lid to the opening. The port is coupled to the lid and/or the one or more walls. The port enables elevated pressure of a gas inside the extraction container relative to an exterior environment of the extraction container to vent to the exterior environment. The strainer spans a portion of the one or more walls such that the chemical compound and the solvent can be separated from the plant matter with the extraction container following the extraction.

The flexible polymer may be made from a silicone material and/or a polypropylene that can be heated in an oven, a toaster oven, a conventional oven, and/or a microwave oven. The strainer may also be made of the flexible polymer.

The base may be ovoid, and the one or more walls may include a first wall and a second wall extending up from two sides of the ovoid, such that the first wall and the second wall become adjacent when the extraction container is flattened for storage. The fastening mechanism may include a locking track along the opening. The strainer may span a portion of the first wall and a portion of the second wall and folds when the extraction container is flattened for storage.

The extraction container and the flexible polymer may be able to withstand a temperature of at least 250 degrees Fahrenheit and the fastening mechanism can withstand an internal pressure differential of 2 atm. The one or more walls may include a fill mark for the plant matter and/or a fill mark for the solvent.

The port may include a one-way pressure release configured to only permit the gas to be expelled from the interior of the extraction container to the exterior environment of the extraction container. The fastening mechanism may form an airtight seal. The filter receiver may be integrated in the port, coupled to the port, and/or spanning a different portion of the one or more walls, the filter receiver configured to receive a filter for filtration of the solvent to remove the plant matter. The filter may be a silk mesh, a grease screen, and/or a stainless steel mesh.

The extraction container may include an odor filter that may be coupled to the port to reduce odors expelled from the interior of the extraction container during venting. The extraction container may also include a variable pressure release configured to adjust a venting pressure at which an elevated pressure of the gas inside the extraction container vents to the exterior environment.

In another embodiment, a method for extracting a chemical compound from a plant matter includes placing the plant matter inside an extraction container. The extraction container includes a base that is flat such that the extraction container can rest upright on a surface during an extraction, one or more walls comprised of a flexible polymer coupled to the base and forming both an interior of the extraction container for holding the plant matter and an opening at the top of the extraction container, a fastening mechanism enabling air-tight fastening of the opening, and a strainer coupled to and spanning a portion of the one or more walls. The method adds a solvent to the inside of the extraction container at a first temperature and closes a fastening mechanism of the extraction container.

The method then heats the extraction container past a second temperature that is higher than the first temperature for a period of time to extract the chemical compound from the plant matter. The extraction container is cooled below the second temperature, and the solvent carrying the chemical compound is decanted out of the extraction container and through the strainer to result in a rapid, single-tool extraction process for the chemical compound.

The method may knead the plant matter within the extraction container through the flexible polymer to reduce processing tools, reduce process steps, and/or reduce cleanup. The extraction container may further include a port configured to vent elevated pressure inside the extraction container relative to an exterior environment of the extraction container to the exterior environment at one of at least two variable pressure settings. The method may adjust a variable pressure setting to determine a venting pressure, and vent the extraction container through the port.

The extraction container may further include a filter receiver spanning a different portion of the one or more walls and configured to receive a filter. The method may place the filter in the filter receiver. The filter may be a silk mesh, a grease screen, and/or a stainless steel mesh. The port of the extraction container may be coupled to an odor filter to reduce odors expelled from the interior of the extraction container during venting. The extraction container may be heated in a conventional oven and/or toaster oven. The plant matter may include a cannabis plant and the solvent includes a fat, an oil, and/or an alcohol.

In yet another embodiment, an extraction bag includes a base comprised of a flexible polymer and flat such that the extraction bag can rest upright during an extraction when the extraction bag is filled with a solvent and a plant matter and the base is placed on a surface. The extraction bag also includes one or more walls comprised of the flexible polymer coupled to the base and forming both an interior of the extraction bag for holding the plant matter and the solvent, and an opening at the top of the extraction bag. A fastening mechanism is configured to fasten the opening in a closed position. The extraction container also includes a port coupled to the one or more walls enabling gas inside the extraction bag to vent to an exterior environment. The extraction container also includes a strainer comprised of the flexible polymer and spanning a portion of the one or more walls such that a solution includes the solvent and a chemical compound extracted from the plant matter can be separated from the plant matter with the extraction bag following the extraction.

### BRIEF DESCRIPTION OF THE DRAWINGS

The embodiments of this disclosure are illustrated by way of example and not limitation in the figures of the accompanying drawings, in which like references indicate similar elements and in which:

FIG. 1 illustrates an extraction container for extracting a chemical compound (also referred to herein as a “compound”) from plant matter, the extraction container able to act as a single, rapid extraction tool for a wide variety of compounds, the extraction container including a base and one or more walls forming an interior and an opening that may be closed with a fastening mechanism, the interior to receive plant matter that may be manipulated (e.g., masticated through a flexible polymer wall) and also receive a solvent to begin extracting the chemical compound, the extraction container further including a strainer for straining the plant matter and one or more ports for venting pressure and/or filtering a solution of the solvent and compound, according to one or more embodiments.

FIG. 2 illustrates the extraction container of FIG. 1, further illustrating a heat and/or a pressure applied to the extraction container to assist in extracting the compound into the solvent as a solute to form the solution, and any evolved and/or evaporating gas (e.g., from heating, chemical reactions) able to exit from a port to an exterior environment to relieve a pressure, according to one or more embodiments.

FIG. 3A further illustrates the extraction container of FIG. 1, and specifically illustrates decanting and/or filtering the solution carrying the compound, according to one or more embodiments.

FIG. 3B further illustrates the extraction container of FIG. 1, and specifically illustrates utilizing a manipulation of a flexible wall of the extraction container to assist in decanting and/or filtering the solution, according to one or more embodiments.

FIG. 4 illustrates another example of the extraction container, including a lid for closing the opening and a filter receiver for receiving a filter, according to one or more embodiments.

FIG. 5A illustrates a side view of yet another example of the extraction container, instantiated as an extraction bag, the extraction bag enabling a rapid, single tool for effecting a wide variety of extractions, including within a common household oven and/or toaster oven, according to one or more embodiments.

FIG. 5B illustrates a top view of the extraction bag of FIG. 5A, according to one or more embodiments.

FIG. 6A illustrates a filter system that may be used to filter the solution carrying the compound, including for example through fastening to a port of the extraction bag, according to one or more embodiments.

FIG. 6B illustrates a one-way pressure release that may be used to release gas and/or a pressure inside the extraction container, and which may be fastened to a port of the extraction bag, according to one or more embodiments.

FIG. 6C illustrates a variable pressure release that may be used to regulate release of gas and/or a pressure inside the extraction container, and which may be fastened to a port of the extraction bag, according to one or more embodiments.

FIG. 6D illustrates an odor filter that may be used to trap and/or filter gas and/or odorous compounds escaping from the plant matter, solvent, compound, and/or other sources, and which may be fastened to a port of the extraction bag, according to one or more embodiments.

FIG. 7 illustrates a first portion of a compound extraction process flow, according to one or more embodiments.

FIG. 8 illustrates a second portion of the compound extraction process flow, according to one or more embodiments.

FIG. 9 illustrates a third portion of the compound extraction process flow, according to one or more embodiments.

FIG. 10 illustrates a different compound extraction process flow, according to one or more embodiments.

FIG. 11 illustrates a process for extracting tetrahydrocannabinol (THC), cannabidiols (CBD), and/or other cannabinols from a cannabis plant, according to one or more embodiments.

FIG. 12 illustrates the use of the extraction container for the extraction, storage, and/or dispensing of vanillin extract from vanilla beans and/or vanilla pods, according to one or more embodiments.

Other features of the present embodiments will be apparent from the accompanying drawings and from the detailed description that follows.

### DETAILED DESCRIPTION

Disclosed are a method, a device, and/or system of streamlined extraction of a chemical compound from plant matter through a flexible extraction container. Although the present embodiments have been described with reference to specific example embodiments, it will be evident that various modifications and changes may be made to these embodiments without departing from the broader spirit and scope of the various embodiments.

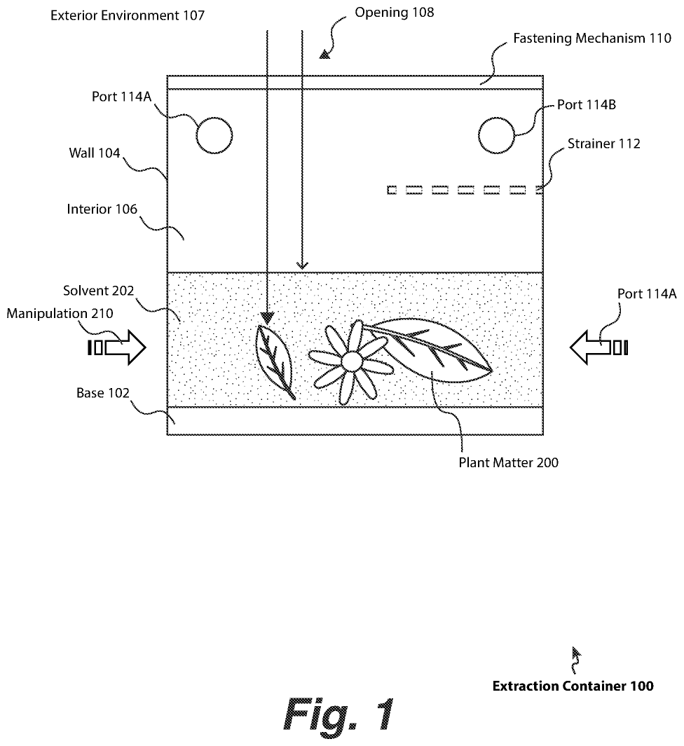

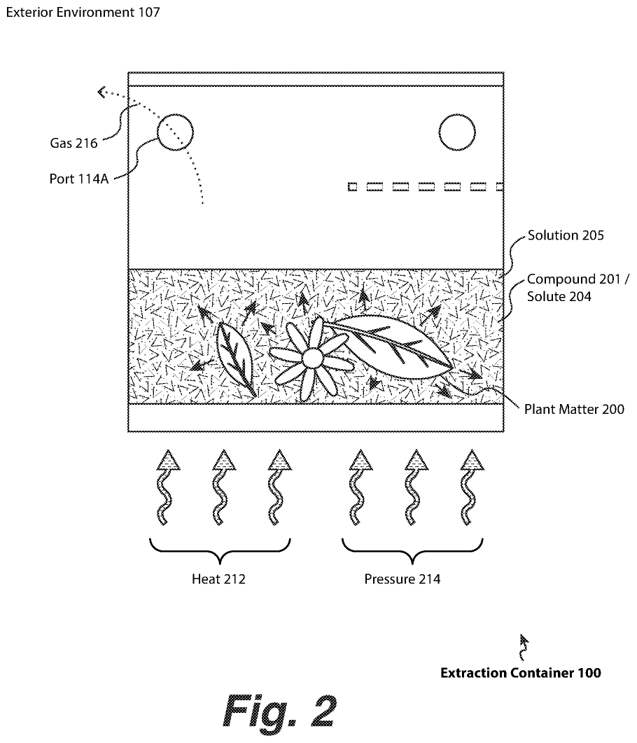

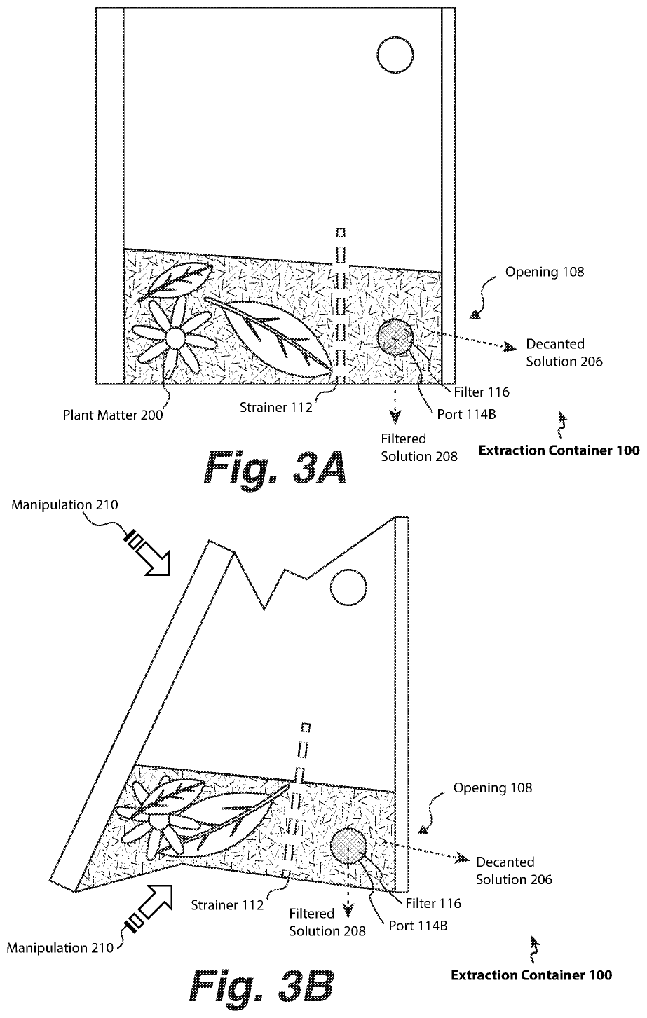

FIG. 1 illustrates an extraction container 100, according to one or more embodiments. The extraction container 100 of FIG. 1 is further illustrated, as one example of its use, in FIG. 2 through FIG. 3B.

The extraction container 100 is a container that may be usable to extract a chemical compound and/or perform chemical reaction. The chemical compound is also referred to herein as the compound 201. The compound 201 may be extracted from biological matter such as a plant matter 200, for example plant tissue, leaves, stems, stocks, flowers, roots, seeds, fruits, and/or other plant matter. As used herein, plant matter 200 may also include fungi, bacterial cultures, yeast cultures, algae, and similar organisms.

In one or more embodiments, the extraction container 100 may include a base 102 and one or more walls 104. The base 102 and the one or more walls 104 may form an interior 106 and an opening 108. The opening 108 may be closable, for example with a fastening mechanism 110. The base 102 may permit the extraction container 100 to stand in an upright position, whether or not holding contents.

In one or more embodiments, all or a portion of the extraction container 100 may be constructed with a flexible polymer that may be selected for suitability for the intended type of plant matter 200, compound 201, and/or solvent 202. In one or more embodiments, the extraction container 100, and specifically the base 102 and/or the walls 104, may be made from a food-grade polymer such as silicone, high-density polyethylene (HDPE) and/or low-density polyethylene (LDPE).

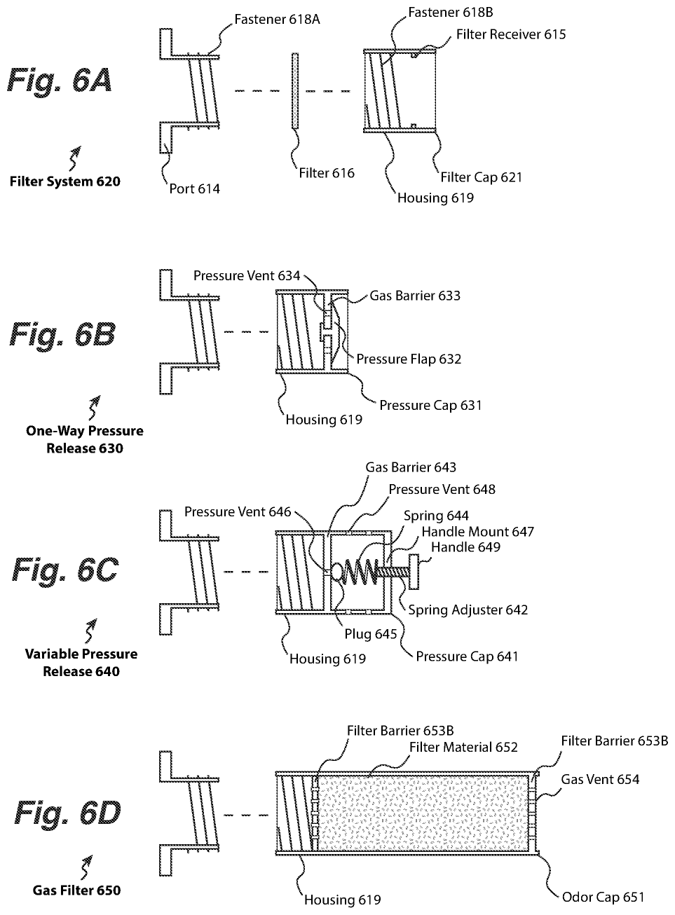

The plant matter 200 may be added through the opening 108 to the interior 106. In one or more embodiments, measurement markings or other fill guides may be placed on the extraction container 100, for example on the wall 104, to assist a user in measuring and/or following extraction protocols or recipes. A solvent 202 may also be added, which may be selected for its capacity to extract and/or dissolve the compound 201. The plant matter 200 may be a plant or mix of plants containing pharmacoactive instance of the compound 201 and the solvent 202 may be selected for its capacity to dissolve the pharmacoactive instance of the compound 201. By way of example, the plant matter might be masticated cinchona bark usable for extraction of quinine (e.g., the compound 201), and the solvent 202 may be a mixture of at least one hydrocarbon and at least one additional solvent component selected from a chlorinated hydrocarbon, ketone or alcohol. In another example, the compound 201 may be caffeine and the solvent 202 may be water. In yet another example, the compound 201 may be tetrahydrocannabidinol (THC) and/or cannabidiol (CBD) and the solvent 202 an edible lipid such as butter and/or coconut oil, as further shown and described in the embodiment of FIG. 6.

Once placed in the interior 106, the plant matter 200 and/or the solvent 202 may be manipulated through a manipulation 210, for example massaging, mastication, crushing, and/or other physical interaction. Where the base 102 and/or the wall 104 is made of a flexible material (e.g., silicone), the manipulation 210 may occur through the wall 104 and/or base 102. In one or more embodiments, an advantage of the extraction container 100 may be the ability to manipulate the plant matter 200 while inside the extraction container 100 and/or while emersed in the solvent 202. The user may be able to provide the manipulation 210 while viewing the plant matter 200 such that the user can ensure sufficient breakdown and/or mastication of the plant matter 200, and/or observe other properties such as the changing color of the solvent 202 and/or the evidence of any chemical reactions.

The extraction container 100 may further include one or more ports 114 (e.g., a port 114A, a port 114B), as further shown and described throughout the present embodiments. The ports 114 may be configured as permanently open or as closable holes within the extraction container 100. The ports 114 may occur through the base 102 and/or wall 104. The ports 114 may enable limited exchange of the contents of the interior 106 with an exterior environment 107, for example gas exchange, liquid exchange, and/or solid exchange. In one or more embodiments, the port 114 may be utilized to vent pressure from the interior 106 to the exterior environment 107, as further shown and described in FIG. 2 and throughout the present embodiments. In one or more other embodiments, the port 114 may be used to drain, decant, and/or filter the solvent 202 carrying the compound 201, as further shown and described in conjunction with the embodiment of FIG. 3A and FIG. 3B and throughout the present embodiments. The port 114 may include a sealing mechanism, for example screw threads allowing for placement of a cap or lid. In one or more embodiments, the port 114 may include and/or also may be configured to receive numerous attachments, e.g., one-way pressure releases, variable pressure releases, odor filters, fluid filters, and/or other attachments, for example as shown and described in conjunction with the embodiments of FIG. 6A through FIG. 6D.

FIG. 2 illustrates the extraction container of FIG. 1. For clarity of explanation and visual presentation, several elements are unlabeled compared with FIG. 1, for example the base 102, the wall 104, the interior 106, the opening 108, the fastening mechanism 110, the port 114B, and the solvent 202.

As illustrated in the embodiment of FIG. 2, the compound 201 (and/or one or more other compounds 201, e.g., a compound 201A, a compound 201B, etc.) may be extracted from the plant matter 200. The compound 201 when dissolved in the solvent 202 may form the solution 205. The compound 201, when present in and/or dissolved in the solvent 202, may be referred to as the solute 204.

The conditions of the extraction may vary based on the plant matter 200 and/or its pre-processing, the compound 201 to be extracted, the solvent 202, the ratio of plant matter 200 to solvent 202, the amount of solvent 202 and plant matter 200 within the interior 106, the desired concentration of the compound 201 as the solute 204, and/or the time over which the extraction is to occur (e.g., seconds, minutes, hours, days, and/or longer periods of time). As known in the chemistry arts and/or chemical engineering arts, appropriate solvent 202 may be selected for the compound 201, along with appropriate heat 212 and/or appropriate pressure 214 to increase the efficiency, yield, and/or completion of the extraction. A user may also adapt common recipes, especially for cosmetic, culinary, herbal, and/or some medicinal compounds 201.

Depending on the conditions of extraction, a gas 216 may build pressure within the interior 106, especially any void left unfilled by the mixture of solution 205 and the plant matter 200. The gas 216, for example, may be one or more of (i) the expansion of preexisting atmosphere or gas within the interior 106 that may be expanding due to the heat 212 and/or reduction in pressure 214, (ii) the liberation of gas 216 dissolved in the solution 205, (ii) the evaporation of the solvent 202 and/or other volatiles, (iii) products of a chemical reaction occurring in the solution 205, including for example decomposition of the plant matter 200 and/or reactions of the compound 201 (e.g., gas generated from an acid-base reaction, escape of carbon dioxide generated from decarboxylation of a carboxylic acid due that may occur due to heat 212, etc.).

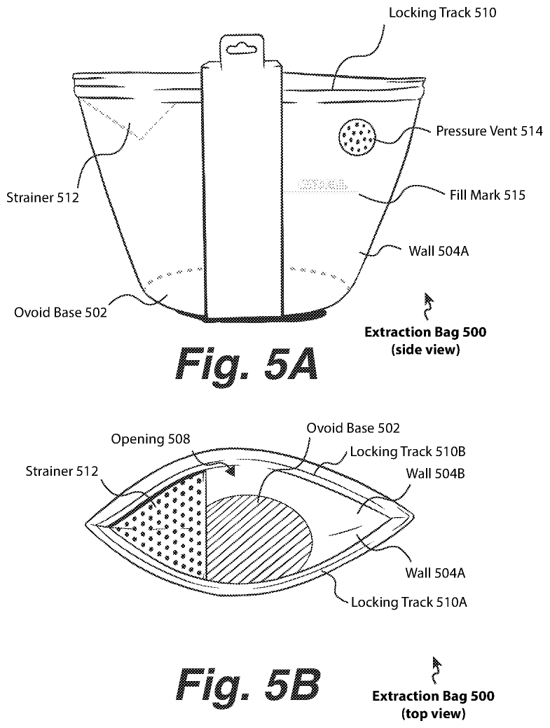

The gas 216 may be allowed to exit through the port 114, which is specifically illustrated in the present embodiment as the port 114A. The port 114 may be a through-hole in the wall 104, which may or may not include additional supporting structure that can increase structural integrity of the wall 104. In one straightforward example, the wall 104 may be made of a polymer such as silicone and the port 114 may an “+” shaped slit in the silicone forming four flaps. The slits may be optionally reinforced with a circular reinforced edge encompassing the “+”, and/or a thickened wall 104 at a location of the slits, either or both of which may decrease likelihood of tearing. to prevent tearing. The gas 216 may push the flaps open after pressure builds on the interior 106, but rigidity and/or restoring force of the flaps may inhibit leakage or spillage of the solution 205. Such element cut in the side may ease manufacturing of the port 114A and allow for production of relatively low-cost extraction containers 100. In one or more other embodiments, the port 114 may be directly attached to more complex venting and/or pressure regulation mechanisms, for example as shown and described in conjunction with the embodiments of FIG. 6B and FIG. 6C. In one or more other embodiments, the port 114 may be configured to attach to and/or receive one or more attachments which may regulate the gas 216 exiting the interior 106 (and/or gas from the exterior environment 107 entering the interior 106). Depending on the anticipated pressure buildup inside or outside of the extraction container 100 during use, the fastening mechanism 110 may be designed to withstand the expected pressure and/or may be bolstered or reinforced for elevated pressures. For example, where the fastening mechanism 110 is an interlocking track made form a flexible polymer, e.g., the locking track 510 as shown and described in conjunction with the embodiment of FIG. 5, a locking linear bag clip may be additionally installed across the entire opening 108 to raise the pressure capacity of the interior 106. In one or more embodiments, the fastening mechanism may be liquid-tight, oil-tight, watertight, and/or airtight.

The heat 212 may be provided by a variety of devices and/or methods known in the art, for example, an oven (including a residential cooking oven, a pressure cooker, a commercial oven, an autoclave), a conventional oven (e.g., a residential cooking oven), a microwave oven (including a residential microwave oven), a heat lamp, direct sunlight, etc. However, in one or more embodiments, the extraction container 100 may be produced and configured to be especially useful as a low cost, single tool solution to perform extractions in a residential context, including using a consumer oven as the source of the the heat 212. The pressure 214 may be provided may be provided by a variety of devices and/or methods known in the art, for example a pressure cooker, an autoclave, a barometric pressure chamber, etc.

It will be noted that although the arrows of the heat 212 and the pressure 214 are illustrated in FIG. 2 as one-way arrows shown for simplicity of explanation, cooling and/or reduction in pressure compared to a baseline is also possible. It will therefore be evident to one skilled in the art that the extraction container 100 may be equally subject to cooling and/or a reduction in pressure. Similarly, the gas 216 may be able to move into the interior 106 from the exterior environment 107 when the port 114 is open and/or properly configured for intake.

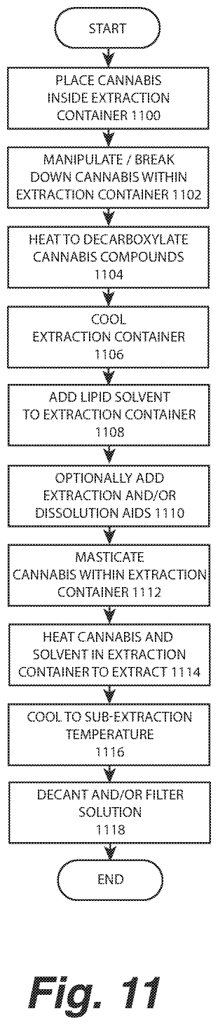

It will be recognized that although extraction may be one goal of certain embodiments of the extraction container 100, and despite being referred to as the “extraction container”, certain chemical reactions may also be carried out inside the extraction container 100 regardless of whether an associated extraction occurs. In other words, the extraction container 100 may be usable as a reaction vessel where appropriate for a given set of reactants, reagents, catalysts, and/or products. In one or more embodiments, the reaction may be performed as a pre-process, interstitial process, and/or post-process relative to the extraction. In one or more other embodiments, the extraction container 100 may be used solely as a reaction vessel, for example solely to perform decarboxylations as illustrated in operation 1104 of FIG. 11. In another example, the extraction container 100 may be used as a fermentation container and an “alcohol lock” added to one or more of the ports 114.

FIG. 3A and FIG. 3B illustrate the removal of the solution 205 from the extraction container 100. In a straightforward example, the solution 205 may be simply poured out of the opening 108 after following the extraction and/or any chemical reaction. However, in one or more embodiments, the solvent 202 may be decanted, strained, and/or filtered. In one or more embodiments and the embodiment of FIG. 3A, the extraction container 100 may include a strainer 112 that may be integrated into the interior 106 and that the solution 205 may be strained through as the solution 205 is removed from the extraction container 100.

In one or more embodiments, and the embodiment of FIG. 3A, the extraction container 100 may be turned on its side and the strainer 112 may catch some or all of the plant matter 200, which may be retained behind the strainer 112. The solution 205 may be poured out of the opening 108, shown as the decanted solution 206, and/or may exit through a port 114, specifically shown in FIG. 3A as the port 114B.

If exiting through the port 114, the port 114 may include, may be configured to couple to couple to, and/or may receive a filter 116. For example, the filter 116 may be a fine mesh filter that may catch substantially all portions of the plant matter 200, including fine portions that may have broken off during the manipulation 210 such as mastication. In one or more embodiments, the mesh may be a 5 mesh size (e.g., standard steel woven mesh sizes), an 8 mesh size, a 20 mesh size, a 30 mesh size, or a 40 mesh size. The filter 116 may be a silk mesh, a grease screen, and/or a stainless steel mesh. The user may therefore be able to easily filter the solution 205, directly using the extraction container, resulting in the filtered solution 208. The filter 116 may also include fine-filter such as charcoal filters, and/or additional components catalytic screens (e.g., a platinum and/or palladium screen), degassers, and/or other post-processing elements.

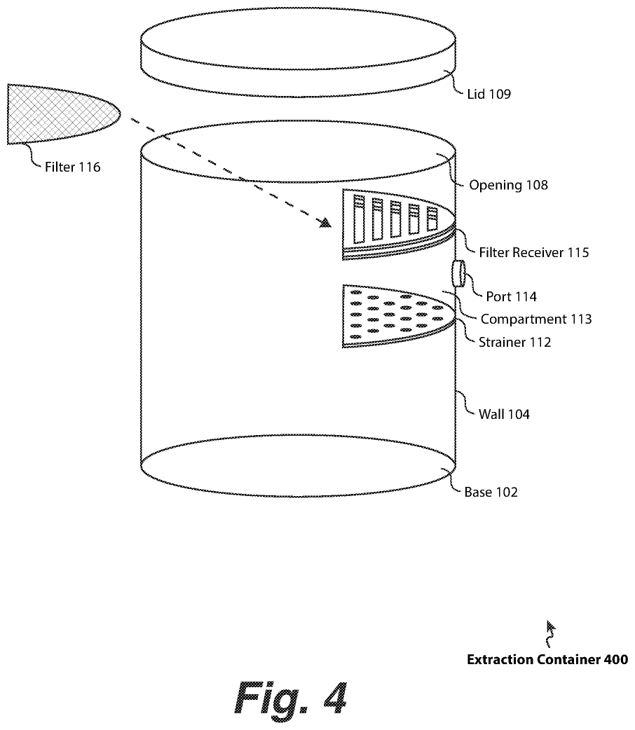

Although a single instance of the strainer 112 is illustrated in FIG. 3A, multiple strainers 112 and/or filters 116 (e.g., a strainer 112A, a strainer 112B, etc.) may be placed in succession (e.g., as shown in FIG. 4), including with a gradient of pore-sizes or hole-sizes across each sequential strainer 112. This arrangement may promote efficiency of straining such that there is a lower probability of clogging and/or such that different sizes of the plant matter 200 may be captured in different compartments between instances of the strainer 112.

FIG. 3B illustrates that, where portions of the extraction container 100 are flexible, the user may provide a manipulation 210 to push, squeeze, and/or apply pressure against the solution 205 to aid in removal, straining, and/or filtration. In one or more embodiments, and as shown in FIG. 3B, the wall 104 may be made from a flexible polymer allowing for the walls to collapse and/or the extraction container 100 to “crush”, squeezing out the solution 205. In one or more other embodiments, the extraction container 100 may be a flexible bag without a base 102, which may also allow for squeezing and removal of the solution 205. Additional pressure may help to remove or filter the solution 205 through highly resistive filters and/or to filter solutions 205 that are viscous (e.g., oils, syrups). In one or more other embodiments, both the base 102 and the walls 104 may be made of a flexible material. During squeezing and/or “crushing” of the extraction container 100, any pressure vent (e.g., the port 114A) may be closed (e.g., with a cap), may have the user's thumb held over it to create an air-tight seal, and/or the manipulation 210 may be applied below the port 114A such that no solvent 202 exists the interior 106 through the port 114A. In one or more other embodiments, there may be a single port 114, where a pressure vent is attached during extraction and then replaced with the filter 116 during the removal of the solution 205.

In one or more embodiments, it will be recognized that the opening 108 may be relatively small, for example an enlarged instance of the port 114 through which the plant matter 200 may be placed and removed, and which may tightly seal with threads to be liquid-tight, oil-tight, watertight, and/or airtight.

FIG. 4 illustrates another example of the extraction container 100, referred to as the extraction container 400. In one or more embodiments and the embodiment of FIG. 4, the extraction container 400 may include a circular instance of a base 102, a single flexible wall 104 attached to the base forming a cylindrical interior, and a circular instance of the opening 108 that may be closed with a lid 109. The lid 109 may be a screw-on lid, a friction fitting lid, a lid held in place with clips, and/or may fasten with another mechanism known in the art. In one or more embodiments, the wall 104 may be flexible, but may transition to and/or include a ridged screw-top allowing the lid 109 having screw threads to securely and/or form an air-tight fit (e.g., air-tight within a range of anticipated pressure differences between the interior 106 and the exterior environment 107).

The extraction container 400 may include one or more instances of a strainer 112, which may span a portion of the circle cross-section of the cylinder of the interior 106. For example, the portion of the circle may be a semi-circle, or may be a cross section resulting from the intersection of a line with the circle of the cross section at any two points along the circle (e.g., e.g., resulting in a cross section area for the strainer 112 that may be larger than a semi-circle or smaller than a semi-circle).

In one or more embodiments and the embodiment of FIG. 4, the extraction container 400 may include a filter receiver 115 which may be configured to receive a filter 116, which may be of the same or similar shape as the filter receiver 115. In the example embodiment of FIG. 4, the filter receiver 115 may be made of two layers and/or flaps of material, each having openings and/or pores, and which each may securely hold a filter 116 which may be slid between the two layers. The solution 205 may be poured out of the extraction container 400 after removing the lid 109, including optionally passing through both the strainer 112 and the filter receiver 115. A compartment 113 may exist between the strainer 112 and the filter receiver 115 depending on an orientation of the extraction containers, optionally accessible and/or drainable with a port 114 such that fine plant matter 200 moving through the strainer 112 but too fine to pass the filter 116 may be removed.

The filter 116 may be removable, disposable, and/or reusable following cleaning. The strainer 112 and/or the filter receiver 115 may be flexible such that the extraction container 400 can be squeezed, “crushed”, and/or collapsed for storage. A flexible instance of the filter receiver 115 may also permit the layers and/or flaps to be pulled apart for cleaning. In one or more embodiments, where the lid 109 forms and air-tight seal, the extraction container 400 may be collapsed and the lid 109 applied to hold a compact shape of the extraction container 400 for reduced-size storage.

In one or more other embodiments, it will be noted that the strainer 112 and/or filter receiver 115 may be set at an angle relative to the base 102, opening 108, and/or lid 109, for example forming a partial ellipse, a parabola and/or a hyperbola.

FIG. 5A and FIG. 5B illustrate an instance of the extraction container 100, referred to as the extraction bag 500, viewed from a side and the top, respectively, according to one or more embodiments. In one or more embodiments and the embodiment of FIG. 5A, the extraction bag 500 may include an oval base 502 (e.g., an instance of the base 102) that may form an ovoid and/or circular shape, two walls (e.g., a wall 504A and a wall 504B coupled to the oval base 502 and protruding upward until each of the wall 504A and the wall 504B may coverge and become parallel, the resulting interior 106 transitioning and/or tapering from a cylindrical shaped volume near the oval base 502 to a thin “sandwich” of wall-interior-wall near the opening 108 (e.g., similar to a triangular prism with the square base replaced with an ovioid and the four square walls replaced with two curving square walls). In one or more other embodiments, it will be recognized that the extraction bag 500 may dispense with the oval base 502 and may be used to perform extractions and/or reactions lying flat on a surface (e.g., a wall 104). In such case, the extraction container 100 may lay on a wall 104A and the opening 108 and/or the port 114 may be set in an opposing wall 104B.

The extraction bag 500 may include a strainer 512 that may be made from a layer of perforated material spanning the wall 504A and the wall 504B. When straining the solution 205, the strainer 512 may span the opening 508 through which the solution 205 may be decanted, and/or bulge out of the opening 508, forming a dam with exit-holes through which the solution 205 may exit. When the extraction bag 500 is collapsed for storage, the strainer 512 may fold into a triangular wedge and/or folded conic section wedge that fits inside the interior 106.

The extraction bag 500 may include a pressure vent 514. In one or more embodiments, the pressure vent 514 may include one or more holes, linear slits, or other shapes in the wall 504A that may be self-sealing at a first pressure differential between the interior 106 and the exterior environment 107, but may be calibrated to release gas (e.g., the gas 216) at a different pressure differential and/or pressure threshold. For example, the holes may be calibrated to release pressure when a pressure differential of above 0.25 atm difference, 1 atm difference, 2 atm difference, and/or 10 atm difference occurs between the inside and outside of the extraction bag 500. In one or more embodiments, the material of the wall 504 may be thickened around the pressure vent 514.

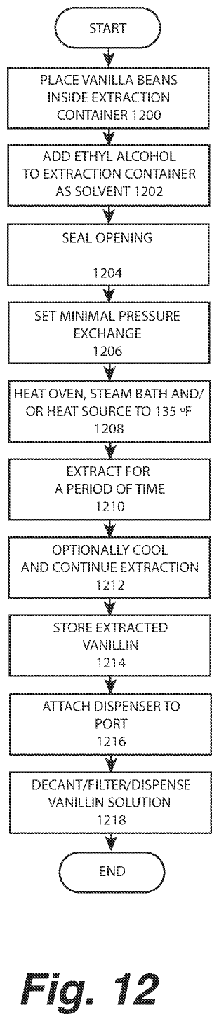

The extraction bag 500 (and/or the extraction container 100) may include a fill mark, for example the fill mark 515. The fill mark may be a maximum fill mark, a solvent fill mark, a plant matter fill mark, and/or may represent one or more recipes for specific types of extraction, including for example the extractions of FIG. 11 and FIG. 12. Instructions may also be placed on the outside of the extraction bag 500 (and/or the extraction container 100), for example embedded in a mold for the flexible polymer and/or printed on the walls 104.

Although the extraction bag 500 may be a variety of sizes, in one or more embodiments it may be about eight inches tall, include a oval base 502 of six inches on its major axis of the oval by five inches on its minor axis oval, with the walls 504 eight inches in width at the opening 508.

FIG. 5B illustrates a top view of the extraction bag 500, including illustrating the wall 504A, the wall 504B, a locking track 510A and a locking track 510B, where the locking track 510A and the locking track 510B each contain complementary locking components (e.g., similar to a Ziplock® bag). Alternatively, or in addition, a locking clamp may be utilized to secure or provide additional security to the locking track 510.

The locking track 510 may enable an air-tight seal. In one or more embodiments, a bag clip or one or more other types of clip or clasp may be added to increase the ability of the extraction container 100 to contain pressure.

In one or more embodiments, the extraction bag 500 may be designed and configured for household use including preparing, cooking, and/or storing edible products. The extraction bag 500 may be made from a food-grade polymer such as silicone, polypropylene, and/or polyethylene. In one or more preferred embodiments, the extraction bag 500 may be produced from a single material and in a single mold, which may decrease manufacturing cost and enable a lower price point enabling a relatively versatile tool for a consumer and/or residential environment. The extraction bag 500, for example, may be able to be utilized to prepare and store culinary extractions, herbal extractions and/or infusions, indigenous remedies, and/or medicinal extractions. By way of example, the extraction bag 500 of FIG. 5A and FIG. 5B may be utilized to perform some or all of the extractions of FIG. 11 and FIG. 12.

FIG. 6A through FIG. 6D illustrate examples of elements that may be included within, attached to, and/or integrated with a port 114 or another opening in the extraction container 100, according to one or more embodiments. Although the port 614 (e.g., an instance of the port 114) is illustrated in cross section with screw-threads as the fastener 618, it will be obvious to one skilled in the art that may possible fasteners and/or connectors may be utilized, or that the element filtering, releasing pressure, and/or filtering odor may be permanently affixed.

FIG. 6A illustrates a filter system 620 in cross-section, according to one or more embodiments. A port 614 may include a fastener 618A such as male screw threads. A filter cap 621, also shown in cross-section, may fasten to (e.g., screw onto) the port 614. The filter cap 621 may include a housing 619 that forms a cylinder that may include a hollow opening to allow the solvent 202 to move through the filter cap 621, and may further include a filter 616. The filter 616 may be held in place in the interior of the housing 619 within a filter receiver 615, for example a circular ring of material protruding from the hollow interior of the filter cap 621 and/or a layer of backing material with relatively large openings to support the filter 616 while hydrostatic pressure is applied against it.

FIG. 6B illustrates a one-way pressure release 630, according to one or more embodiments. A pressure cap 631 may include a housing 619 forming a hollow cylindrical interior interrupted by a gas barrier 633. The gas barrier 633 may be breached by one or more pressure vents 634 along with a pressure flap 632 that may be made from a relatively flexible material (e.g., able to flex enough to deform away from the pressure vent 634 to let pressure out from behind the gas barrier 633). The pressure flap 632 may be fastened through a variety of devices and/or methods, including for example installation of an oversized portion locking into place through a dedicated through-hole in a central portion of the gas barrier 633, as shown in FIG. 6B. The pressure vent 634 may be configured to a set pressure, for example approximately 0.35 atm pressure differential between the interior 106 and the exterior environment 107 (e.g., 0.35 atm±0.05 atm). In one or more embodiments, the extraction container 100 may be able to interchangeably receive one of several predetermined pressure vents, e.g., 0.25 atm, 1.0 atm, and 3.0 atm. The pressure differential between the interior 106 and the exterior environment 107 may be referred to as the internal pressure differential.

FIG. 6C illustrates a variable pressure release 640, according to one or more embodiments. A pressure cap 641 may include a housing 619 and a gas barrier 643. The housing 619 may further terminate in a handle mount 647 which may hold a handle 649 and a spring adjuster 642 in place and/or in alignment with a plug 645. The handle 649 may be coupled to the spring adjuster 642, and the spring adjuster 642 may be mechanically coupled to an elastic element capable of varying force against the plug 645. For example, in the embodiment of FIG. 6C, the elastic element may be a spring 644. In one or more other embodiments, the plug 645 may have sufficient elasticity (e.g., a rubber material) that the spring adjuster 642 may apply force directly against the plug 645. As known in the art, the plug 645 may have a spherical and/or ovoid shape that seals against a round instance of the pressure vent 646. Upon internal pressure building within the interior 106 to a threshold, the force of the elastic element such as the spring 644 may be overcome a spirt and/or gush of the gas 216 released until the pressure falls below the threshold. The gas 216 may then exit through one or more pressure vents 648 permitting escape of the gas from the chamber formed between the gas barrier 643 and the handle mount 647. The handle mount 647 and the spring adjuster 642 may include mechanisms to the spring adjuster 642 at a correct depression level, for example screw threads in an appropriate shallow thread pitch to enable the spring 644 and/or other elastic element to hold a selected setting. Measurements on the spring adjuster 642, and/or other guidelines may be provided to the user to guide appropriate setting of the variable pressure release 640. Although one example of a variable pressure release 640 has been provided, it will be evident to one skilled in the art that other variable pressure release mechanisms known in the art may be utilized with the port 114 and/or the port 614. Although not shown, a pressure gauge may be integrated into the extraction container 100 and/or a variable pressure release 640, and/or may attach directly to one of the ports 114.

FIG. 5D illustrates a gas filter 650, according to one or more embodiments. An odor cap 651 may include a housing 619 forming a cylindrical interior interrupted by a filter barrier 653 breached by one or more gas vents 654. A filter material 652 may be set in and/or packed into the interior of the housing 619, then may be held in place with a filter barrier 653A that may be removable and may include one or more gas vents 654. The filter barrier 653A may be held in place when the odor cap 651 is coupled (e.g., screwed down to) the port 614. In one or more embodiments, the filter material 652 may include activated charcoal, particulate filters, HEPA filters, volatile organic compound (VOC) filtering media, etc. In one or more embodiments, the gas filter 650 may be an odor filter that may remove odors associated with the plant matter 200, the solvent 202, and/or the extraction process generally. For example, the odor filter may be able to remove some or all of the smell associated with the extraction of tetrahydrocannabinol from cannabis. In one or more embodiments, the gas filter 650 may be a filter to remove volatile organic compounds that may be present in the solvent 202, such as acetone, ethanol, methyl ethyl ketone, and/or methylene chloride.

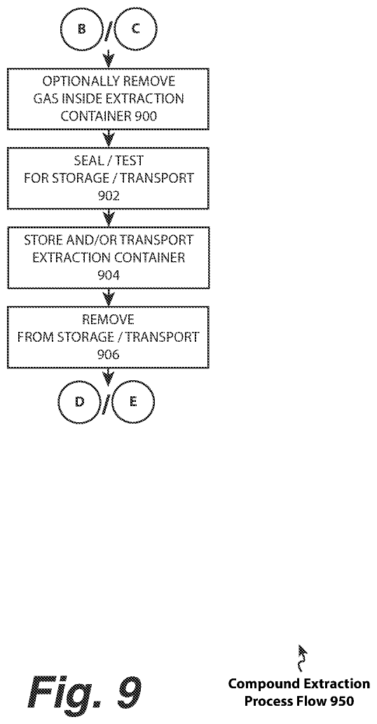

In one or more other embodiments, an attachment for the port 114 may include both a gas intake port and a gas extraction port. For example, and referring to the embodiment of FIG. 1, a pressure release port may be coupled to the port 114A and a gas intake port may be coupled to the port 114B. The gas extraction port may be utilized to remove the gas inside the interior 106, for example for sealing the extraction container 100 for storage and/or shipping, as further described in conjunction with the embodiment of FIG. 9. Alternatively, or in addition, the gas intake port may be used to input an inert gas (e.g., carbon dioxide, nitrogen gas, argon, helium), and the gas extraction port may be utilized to extract the gas displaced as a result. This may also assist in storage and/or shipping utilizing the extraction container 100, for example by removing reactive compounds in the gas 216 (e.g., diatomic oxygen).

In one or more other embodiments, the gas filter 650 may container one or more elements to assist in catalytic decomposition of potentially hazardous molecules (e.g., carbon monoxide) and/or odors molecules (e.g., hydrogen sulfide gas). Although a single filter material 652 is shown in the embodiment of FIG. 6D, it will be evident to one skilled in the art that multiple different filter materials may be utilized, including in succession and/or in sequence.

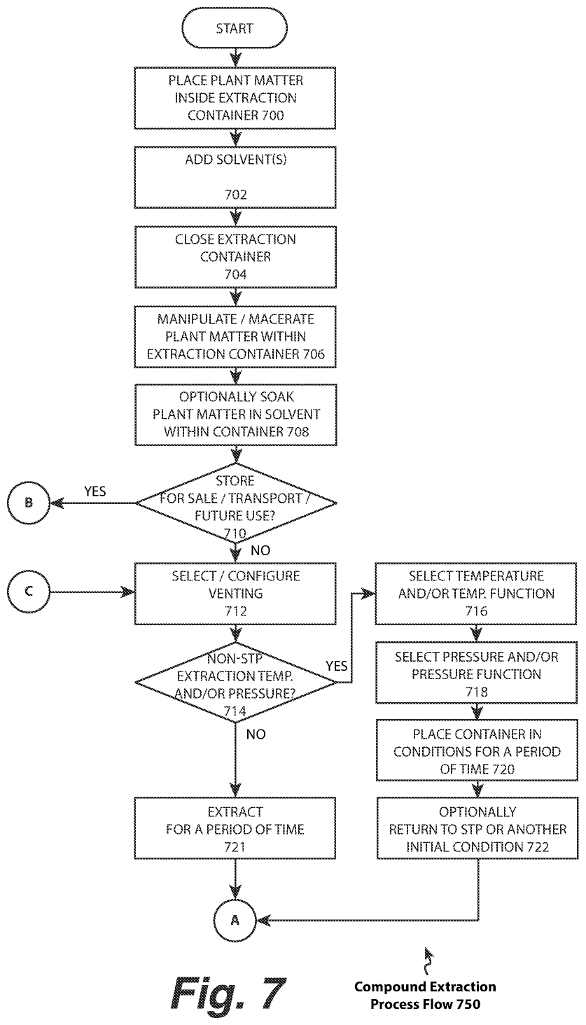

FIG. 7 illustrates a first portion of a compound extraction process flow, the first portion referred to the compound extraction process flow 750, according to one or more embodiments. Operation 700 places plant matter 200 in an extraction container 100. For example, the plant matter 200 may be a plant, a fungus, an algae, and/or a yeast. It should also be noted that a bacterial and/or archaebacterial culture may be utilized in place of the plant matter 200. The plant matter 200 includes one or more target compounds 201 for extraction. The extraction container 100 may be any embodiment of the extraction container 100 contemplated herein, including without limitation the extraction container 400 and/or the extraction bag 500.

Operation 702 includes adding one or more solvents 202 to the extraction container 100. The solvents 202 may be selected appropriately for their capability to extract and/or dissolve the target instances of the compound 201. Operation 704 closes the extraction container 100. For example, a user may seal the opening 108 with the fastening mechanism 110, add any auxiliary fastening mechanisms, close any ports 114, and/or close any other openings in the extraction container 100.

Operation 706 manipulates (which may include maceration) of the plant matter 200 within the extraction container 100. The manipulation (e.g., the manipulation 210) may be enabled and/or enhanced by flexible walls 104 and/or base 102 of the extraction container 100, such that the plant matter 200 can be manipulated without a separate tool or container, and such that a user may not have to come in contact with the plant matter 200, solvent 202, and/or compound 201. Where a portion of the extraction container 100 is translucent, transparent, and/or otherwise includes a see-through portion, a user may be able to visually observe progress of mastication and/or breakdown of the plant matter 200. Where a portion of the extraction container 100 is flexible and sufficiently thin, the user may be able to tactilely perceive progress of mastication and/or breakdown of the plant matter 200.

Operation 708 optionally soaks the plant matter in the solvent 202 within the extraction container 100. Some solvents 202, for example, may take some time to dissolve cutaneous waxy layers of the plant matter 200, or to dissolve cell walls, cell membranes, and/or cellular organelles. Operation 706 and operation 708 may be repeated as necessary.

Operation 710 may determine if the contents of the extraction container 100 should be stored for sale, transportation, and/or later use. For example, the extraction may be most potent, pure, and/or fresh if finalized and/or finished by an end-user, consumer, and/or at a time prior to use. In one or more embodiments, the extraction container 100 may be able to be purchased by a consumer and/or end user in a pre-finished state, and need only to be heated, strained, decanted, and/or filtered prior to use. In such case, operation 710 proceeds along path ‘circle B’ to FIG. 9. If no storage or transfer is to occur, operation 710 may proceed to operation 712.

Operation 712 may select and/or configure any venting that the extraction may utilize. For example, one or more of the attachments of FIG. 6A through FIG. 6D may be selected and installed, e.g., on a port 114. In one or more embodiments, one or more elements for venting may be installed in parallel and/or in combination, for example a pressure vent followed by a gas filter.

Operation 714 determines whether a non-standard temperature and/or pressure extraction is to be performed, in which case operation 714 may proceed to operation 716. Operation 716 may select the temperature at which the extraction will be performed and/or select a temperature function. By way of example, within a residential context, a user may set their oven to 375 degrees Fahrenheit (° F.). A pressure function may follow a timed procedure, whereby the user first sets the temperature to 200° F. for a first time, then 400° F. for a second time, then allows the extraction container 100 and its contents to cool to 80° F. before decanting. In a commercial or industrial context, the user may be able to set an oven or other heat source to follow a prescribed heating function and/or temperature profile that varies as a function of time.

It should be noted that the extraction need not be performed at standard temperature and pressure (STP), and does not necessarily need to return to STP or other initial conditions. For example, in or more embodiments, the initial conditions of extraction may utilize cold solvents (e.g., liquid butane) at or below the freezing point of water at standard pressure. The solvent 202, when added to the plant matter 200, may be at or below the freezing point of water at standard pressure, and the solution 205 may be decanted before rising above the freezing point of water at standard pressure.

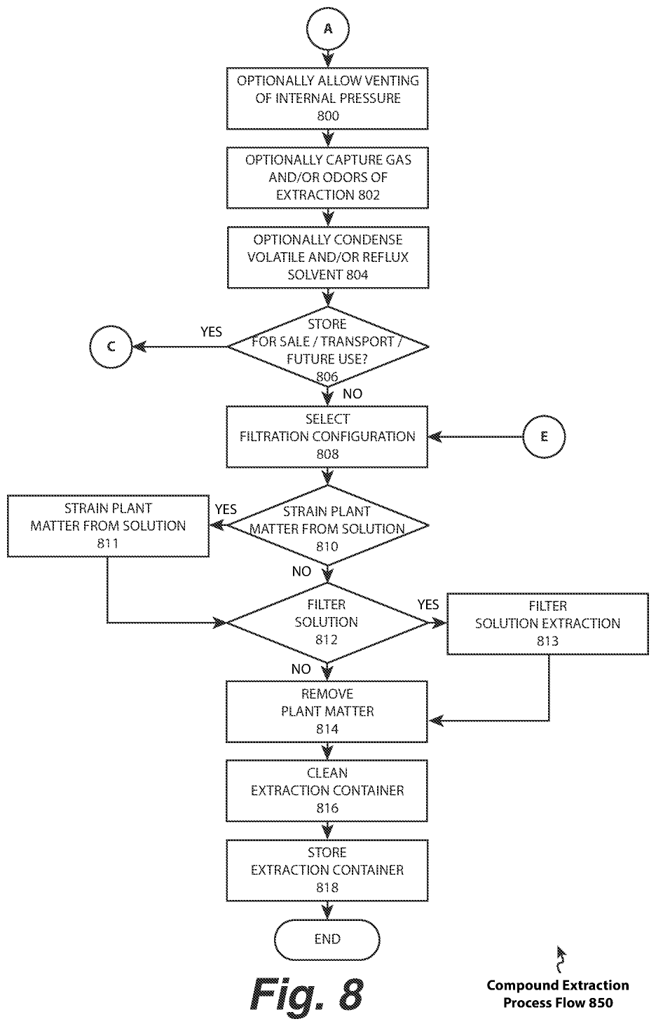

Operation 718 selects a pressure and/or a pressure function, which may occur similarly to selecting a temperature and/or temperature function. Operation 720 places the extraction container 100 in the conditions for a period of time. Operation 722 may then return to STP and/or the initial condition or a different ending condition. If extraction under STP is to occur, operation 714 may proceed to operation 721 to place the extraction container 720 in STP conditions for a period time, then proceed along path ‘Circle A’ to FIG. 8. Similarly, operation 722 may proceed along path ‘Circle A’ to FIG. 8. Although STP is used as an example, operation 714 may as easily determine a different temperature and pressure baseline, for example 72° F. and 1 atm of pressure.

FIG. 8 illustrates a second portion of the compound extraction process flow, referred to as the compound extraction process flow 850, according to one or more embodiments. Operation 800 through operation 804 may run concurrently with operation 720 and/or operation 721. Operation 800 may optionally allow venting of an internal pressure from the interior 106 of the extraction container 100 to the exterior environment 107, for example at one or more preselected pressure differentials. For example, operation 800 may utilize one or more of the attachments illustrated in FIG. 6B and FIG. 6C, and/or a different pressure release device or method. Operation 802 optionally captures gas and/or odors of extraction. For example, operation 802 may utilize the attachment illustrated in FIG. 6D, and/or a different device or method for capturing off-gassing chemical compounds 201, solvents 202, and/or other chemical species.

Operation 804 may optionally condense volatiles (e.g., the solvent 202, the compound 201), for example in a distillation apparatus that may be hooked to the port 114. For example, a condenser tube may be fastened to the port 114, including through a length of tube, where cold water or other liquid may circulate around the condensing tube to lower a temperature of the volatiles and/or gaseous compounds 201. This may allow for capture and/or condensing of certain instance of the compound 201 that may otherwise escape and/or may otherwise be produced at low yield if not captured from the escaping gas 216.

Operation 804 may alternatively, or in addition, reflux the solvent 202. In one or more embodiments, the extraction container 100 may be substantially elongated such that a temperature gradient is establish between any heating at the bottom of the extraction container 100 and/or cooling at a top of the extraction container 100. In such case, solvent may be allowed to rise to the top of the extraction container 100, condense against the upper walls 104 and/or lid 109, and fall back to the base 102 and/or lower walls 104. The lid 109 may include a compartment to hold water or ice to aid in condensation within the interior 106.

Operation 806 determines whether the resulting solution 205, which may now include the compound 201 that is the solute 204, should be stored for future sale, use, and/or transportation, in which case operation 806 may proceed along path ‘Circle C’ to FIG. 9. Where future use is not contemplated or intended, operation 806 may proceed to operation 808 which may select an appropriate device and/or method of filtration to separate the plant matter 200 and the solution 205. For example, filtration may include straining (e.g., through a strainer 112 integrated in the extraction container 100) and/or filtering through one or more screens or fine filters (e.g., once or more instances of the filter 116). As just one example, the filter system 620 of FIG. 6A may be selected, and/or a different filtering system may be selected. Operation 810 determines whether the strainer 112 is to be used, in which case operation 810 may proceed to operation 811 which may strain the plant matter 200 from the solution 205. Where straining is to not be used, the user may have utilized an instance of the extraction container 100 without the strainer 112, and/or may turn the extraction container 100 such that the contents containing both the plant matter 200 and the solution 205 bypass, or otherwise flow past, the strainer 112. Referencing FIG. 3A, the extraction container 100 could be ‘upside down’ relative to the orientation of FIG. 3A such that the solution 205 flows past the strainer 112, and where the filter 116 may be installed on the port 114A instead of the port 114B.

Operation 812 may determine whether the solution 205 is to be filtered to remove residual plant matter 200 and/or other removable molecules and/or compounds 201. If filtration is to occur, operation 812 may proceed to operation 813 which may filter the solution 205. The filteration, for example, may be partially or completely effected through gravity feed and/or hydrostatic pressure (e.g., applied by a manipulation 210 or pressurized air forced through an intake port) that forces the solution 205 through a port 114 having an associated filter 116. Alternatively, or in addition, the filter 116 may be integrated within a filter receiver 115, for example as shown and described in conjunction with FIG. 4.

In one or more embodiments, chromatography may be utilized as a filter to remove certain wanted and/or unwanted chemical compounds. For example, an element attachable to the port 114 effecting a column chromatography may be utilized to extract certain toxins, where the solution 205 may be collected in fractions, and/or where the media may have been prepared for strong binding to the toxins such that they permanently are withdrawn from the mobile phase of the solution 205 moving through the column. In one or more other embodiments, the compound 201 may be targeted by the media then stripped off, for example with a different solvent and/or pH change.

It should be noted that some plant matter 200 may be able to be productively extracted more than once, in which case operation 812 may return to operation 700 (such iteration not shown in FIG. 7 and FIG. 8). In one or more embodiments, different solvents 202 and/or extraction conditions may be utilized on successive extractions, which may vary the compounds 201 extracted.

Operation 814 removes the plant matter 200 from the extraction container 100. In one or more embodiments, the user may unfasten the fastening mechanism 110 and easily dump, scoop, or otherwise remove the plant matter 200. Operation 816 may then clean the extraction container 100, for example with soap and water, another solvent, soaps, surfactants, disinfectants, oxidizers (e.g., ozone, hypochlorite) and/or neutralization compounds for restoring or buffering pH (e.g., baking soda, calcium carbonate, vinegar). Attachments may be removed (e.g., unscrewed or unfastened from the ports 114), and any disposable elements thereof may be discarded prior to cleaning. In one or more preferred embodiments, the extraction container 100 may be able to sustain sufficient temperature, pressurized water scouring, and/or detergents to be ‘dish-washer safe’, which may further enable use within the home.

Operation 818 may store the extraction container 100. In one or more embodiments, the extraction container 100 may include one or more flexible portions, for example the base 102 and/or the walls 104, such that it is collapsible for easy and efficient storage. The extraction bag 500 may flatten into a square shape, each of the wall 104A and the wall 104B collapsing until substantially parallel. The extraction container 400 may flatten into a disk shape, with the lid 109 flattening down to the base 102.

FIG. 9 illustrates a continuation of the compound extraction process flow, referred to as the compound extraction process flow 950, according to one or more embodiments. In one or more embodiments, the extraction container 100 may be utilized to (i) store the plant matter 200 prior to extraction, (ii) store the plant matter 200 and the solvent 202 prior to effective and/or ideal extraction conditions, (iii) store the solution 205 and the plant matter 200 following extraction, and/or (iv) store the solution 205 having the compound 201 but after removal of the plant matter 200. In each case, the extraction container 100 may act efficiently as both a storage device and the device for extraction which optionally can be finished by the end user. The extraction container 100 may also function, when transparent, translucent, or otherwise including a see-through element, to bolster attractiveness at the point of sale (e.g., highlighting the contents and/or the origin of the compound 201 extracted).

In the first example, the extraction container 100 may be used to store, transport, and/or sell the plant matter 200. One or more ports 114 may be used to evacuate and/or replace the air inside the extraction container 100 and/or to remove oxygen. The end-user may then have to add their own solvent 202, which may or may not be sold along with the extraction container 100 having the plant matter 200 inside. In the second example, the solvent 202 may be added to extraction container 100, where prolonged contact may result in an efficient and/or high yield extraction. This may be especially appropriate where the compound 201 is unlikely to degrade over time, or expected to degrade slowly. In the third example, utilizing the extraction container 100 as storage and/or sale packaging may also be appropriate where the extraction is inefficient under the packaged and/or transport condition unless and until the temperature is raised or other extraction conditions are satisfied. The necessary conditions may be effected by the user following purchase and according to instructions that may be provided on the extraction container 100 and/or its packaging. In the final example, the extraction container 100 may be utilized as packaging for the extracted compound 201, to assist in displaying the freshness, source, and/or origin of the plant matter 200. In this case, the user may be further provided with instructions to repeat the extraction at home or in a residential context, empowering the user to perform their own extraction at reduced cost and waste by providing the extraction container 100 as reusable packaging.

Specific possible operations around storage, transport, and/or sale will now be described. Operation 900 optionally removes gas inside the extraction container 900. The gas 216, for example, may include oxygen or other chemical constituents that might adversely spoil, react with, oxidize, and/or chemically reduce the plant matter 200, the solvent 202, and/or the compound 201. Operation 900 may also replace the gas 216 with a different gas, for example an inert gas (e.g., diatomic nitrogen gas, carbon dioxide, argon, helium, etc.). Operation 902 may then seal and/or test the extraction container 100 for storage or transport. For example, auxiliary seals may be added (e.g., a bag clip over the opening 108, one or more zip ties securing ports 114 and/or attachment or caps on the ports 114, etc.). The extraction container 100 may also be tested, for example by holding the extraction container 100 in one or more orientations to ensure no leaks are observed, and/or applying pressure to the exterior (e.g., an instance of the manipulation 210) to ensure no leaks are observed. Operation 904 stores and/or transports the extraction container 100. As known in many industries, many instance of the extraction container 100 may be grouped, boxed, palletized, or otherwise grouped and packaged for shipping or storage. Finally, operation 906 may remove the extraction container 100 from storage and/or transport, for example to be used in extracting the compound 201, displayed for sale, and/or sold.

From the perspective of a manufacturer, the extraction container 100 may represent an operational efficiency by not requiring removal and/or repackaging of the compound 201. Similarly, there may be novelty and/or advantage from the perspective of the end user for any extraction that is performed by the end user, for example ensuring the compound 201 is freshly extracted and/or allowing the user to make customizations (e.g., adding other plant matter 200 to change a taste or smell profile).

Where operation 900 was arrived at along path ‘Circle B’ from operation 710, operation 906 may proceed along path ‘Circle D’ to operation 712. Where operation 900 was arrived at along path ‘Circle C’ from operation 806, operation 906 may proceed along path ‘Circle E’ to operation 808.

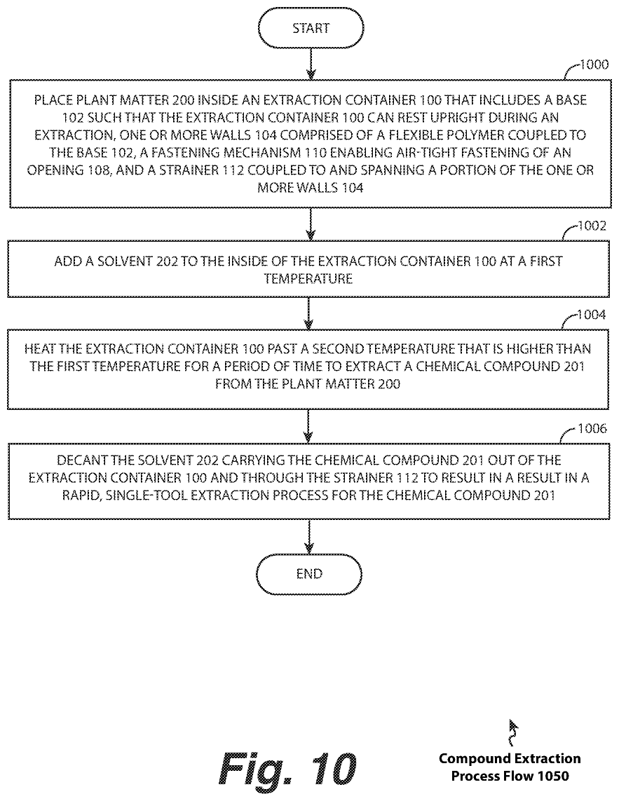

FIG. 10 illustrates yet another example of a compound extraction process flow 1050, according to one or more embodiments. Operation 1000 may place plant matter 200 inside an extraction container 100 that includes a base 102 such that the extraction container 100 can rest upright during an extraction, one or more walls 104 comprised of a flexible polymer coupled to the base 102, a fastening mechanism 110 enabling air-tight fastening of an opening 108, and a strainer 112 coupled to and spanning a portion of the one or more walls 104. Operation 1002 may add a solvent 202 to the inside of the extraction container 100 at a first temperature (e.g., room temperature, ambient temperature, a different starting temperature). Operation 1004 may heat the extraction container 100 past a second temperature that is higher than the first temperature for a period of time to extract a chemical compound 201 from the plant matter 200. Operation 1006 may then decant the solvent 202 carrying the chemical compound 201 out of the extraction container 100 and through the strainer 112 to result in a result in a rapid, single-tool extraction process for the chemical compound 201.

Two examples will now be provided. In the first example, illustrated in FIG. 11, the extraction container 100 may be utilized to efficiently and easily extract TCH and/or CBD from one or more plants of the family Cannabaceae and/or the genus Cannabis. In a second example, illustrated in FIG. 12, the extraction container 100 can be utilized for the extraction, storage, and/or dispensing of vanillin (e.g., the compound 201) extract from vanilla beans and/or vanilla pods (e.g., the plant matter 200), according to one or more embodiments.

FIG. 11 illustrates a cannabis extraction process flow 1150, according to one or more embodiments. Plants of the family Cannabaceae may container numerous compounds that may have medicinal and/or recreational qualities, including THC, CBD, and many others (e.g., each, example of the compound 201). For example, CBD may have been shown to promote relaxation, stress relief, and potential anti-inflammatory benefits (without any metal and/or psychoactive effects), while CBN may induce sleepiness and may offer anti-inflammatory properties.

The patent rights sought and/or claimed herein are relevant to the extraction of cannabis and its compounds 201 because (i) many states of the United States of legalized and/or decriminalized cannabis, (ii) the federal government has legalized certain derivatives, such as CBD, and some plants with Cannabaceae include little or no THC, (iii) some foreign jurisdictions in which patent rights may eventually be sought and/or claimed have legalized and/or decriminalized cannabis and inventions that relate thereto, and/or (iv) the legality of THC in the United States at the federal level may change during the enforceable lifespan of any patent to be issued hereon.

Operation 1100 may place cannabis (e.g., an example of the plant matter 200) inside the extraction container 100, for example the extraction bag 500 of FIG. 5 that may be sized to accommodate twenty-four fluid ounces in volume. In one or more embodiments, about 1 oz of cannabis may be placed inside the extraction bag 500. Operation 1102 may manipulate the plant matter 200 inside the extraction container 100 (e.g., the manipulation 210), for example allowing breakdown of the pieces such as flowers, buds, and/or leaves. The pieces may be broken down until varying between three-quarters inch in size down to one-quarter inch in size. An advantage of operation 1102 being performed inside the extraction container 100 may be to prevent additional tools and/or prevent skin contact between a user and the plant matter 200, especially cannabis which may have microscopic trachea that can irritate skin or inadvertent exposure to the compounds 201.

Operation 1104 heats the cannabis to decarboxylate one or more compounds 201, for example “activating” THC and improving biological absorption by converting THCA to THC-, CBDA to CBD− and/or THCA to CBN−. In one or more embodiments, the user may seal the extraction container 100 and place the extraction container 100 in a residential oven for between 40 minutes to 180 minutes at 240° F. A shorter period of time (e.g., 40 minutes) may primarily convert THCA to THC−, a medium period of time (e.g., 90 minutes) may convert a higher proportion of CBDA to CBD−, and a longer period of time (e.g., 180 minutes) may convert a high proportion of THC to CBN−. During operation 1104, excess gas 216 (including carbon dioxide) may be released through a port 114, for example a pressure vent. To reduce the smell of cannabis which can be potent and potentially unpleasant, in one or more embodiments a gas filter 650 (e.g., using activated charcoal) may be attached to the port 114. Operation 1104 may be an example of utilizing the extraction container 100 as a reaction vessel rather than an extraction vessel.

Operation 1106 may cool the plant matter 200 inside the extraction container 100. At this step, the plant matter 200 may be removed for later extraction, or may be packed and stored directly inside the extraction container 100 for later extraction. Where a one-way pressure release 630 is utilized, cooling may contract remaining carbon dioxide gas inside the extraction container 100 such that little oxygen remains.

If the extraction is to continue, operation 1108 adds a lipid solvent 202 (e.g., a fat, an oil). A lipid solvent 202 may be advantageous because THC, CBD, CBN, and/or other target compounds 201 for extraction may be apolar molecules most miscible in apolar solvents. For example, coconut oil, avocado oil, olive oil, butter, and/or tallow may be utilized. In the present example, two cups (e.g., sixteen fluid ounces) of the lipid solvent 202 may be added.

Operation 1110 may optionally add extraction and/or dissolution aids. For example, one or more chemicals or molecules may aid in the extraction and/or dissolution of the compounds 201 in the solvent 202, and/or may prevent separation of different densities of lipid, including those extracted from the plant matter 200. In the present example, lecithin powder may be added, e.g., one tea spoon per cup of the lipid solvent 202.

Operation 1112 masticates the cannabis within the extraction container 100, for example to expose each portion of the plant matter 200 to the solvent and/or to ensure contact of each portion of the plant matter 200 with, the solvent 202. Operation 1112 may assist the user in not requiring additional tools or containers when preparing for the extraction, and prevent the user from getting their hands dirty or oily. Operation 1114 heats the cannabis to extract the compounds 201. For example, the user may seal the extraction container 100 and place the extraction container 100 on the base 102 in an upright position in a residential oven, optionally on a baking or cooking sheet. Operation 1114 may heat the plant matter 200 and the solvent to between 160° F. to degrees to 200° F. for one to three hours. Again, venting through the port 114 and/or gas filtering through the port 114 may occur. Operation 1116 may then cool the extraction container 100 and its contents to sub-extraction temperatures, and in one or more preferred embodiments touch-safe handling temperature (e.g., 100° F.). Alternatively, or in addition, the solution 205 and plant matter 200 contained therein may be stored at this stage for later use, for transport, and/or for sale. This packaging and display of the cannabis plant may also help alleviate a common challenge within the cannabis industry and its consumers: a buyer not knowing how much plant matter 200 was used in an extraction or its quality, therefore lacking knowledge of how potent and/or concentrated an infused oil or other solution 205 may be. Operation 1118 may decant and/or filter the resulting solution 205 containing the compounds 201, for example through one or more strainers 112 and/or through one or more filters 116. The solution 205 may then be stored or further processed, and the extraction container 100 may then be cleaned with soap and water. As a result, the user such as the consumer may be able to utilize the extraction container 100 to perform a rapid, single-tool extraction process for the chemical compounds 201 in cannabis. The result may be a safer, lower cost, and more controllable experience for a consumer, including the purchase, extraction, storage, and administration of cannabis-derived compounds 201. These positive aspects provide a competitive advantage for a business offering and/or selling the extraction container 100 and therefore can have large economic value.

FIG. 12 illustrates the extraction of vanillin (e.g., the compound 201), according to one or more embodiments. Operation 1200 places vanilla beans and/or vanilla pods into the extraction container 100. For example, two ounces of vanilla beans and/or vanilla pods may be placed in the extraction container 100. The extraction bag 500 of FIG. 5 may be utilized, for example sized to accommodate twenty-four fluid ounces in volume.

Operation 1202 adds a solvent 201 that is ethyl alcohol, for example pure ethyl alcohol, 95% ethanol, and/or 80-proof or higher vodka. For example, 16 fluid ounces of alcohol may be used. Operation 1204 may seal the opening 108, for example closing the locking track 510 and/or adding any secured pressure tolerance enhancement mechanisms such as clips or other fasteners. In one or more embodiments, the opening 108 may be rolled before being secured, similar to a waterproof dry-bag utilized in outdoor activities.

Operation 1206 may optionally set a minimal pressure exchange such that pressure over a threshold can be released, and/or pressure inside the interior 106 can slowly dissipate. For example, the one-way pressure release 630 may be selected and attached to a port 114, and/or an extraction container selected with one or a few small holes within the wall 104 implementing the port 114. Operation 1208 may heat an oven, steam bath, water bath, or other heat source to 135° F. This temperatures may prevent solvent boiling with still increasing the rate of extraction. Where a water bath is utilized, a heavy object such as a stone, silverware, or other material may be placed in the extraction container 100 as needed to reduce buoyancy and counter the less dense solvent and/or any gas remaining in the extraction container 100.

Operation 1210 extracts for a period of time. For example, the heating may remain for a period of 72-90 hours. Alternatively, a shorter period may be utilized, with the heat merely initiating extraction. In one or more embodiments, operation 1210 may proceed directly to operation 1218. However, in one or more other embodiments, and as shown in FIG. 12, operation 1210 may proceed to operation 1212 that optionally cools and continues the extraction. For example, the extraction container 100 may be placed at room temperatures for day, weeks, or even months to continue the extraction.

Operation 1214 stores the extracting vanillin (e.g., the compound 201) within the extraction container 100. It should be noted that operation 1214 and operation 1212 may proceed concurrently, as extraction may continue during storage.

A user may optionally then withdraw the extract directly from the extraction container 100, for example for cooking, baking, soap making, and/or producing cosmetics. Operation 1216 may attach a dispenser to the port 114. The dispenser, for example, may screw onto threads of the port 114, may or may not include a filter, and may allow for a controlled pouring and/or release of the solution 205 comprising the ethyl alcohol and vanillin from the extraction container 100.

Operation 1218 may then decant the solution 205 (e.g., through the strainer 112 to remove the vanilla beans and/or pods), filter the solution 205 (e.g., to remove small pieces of the vanilla beans and/or pods), and/or dispense the solution 205 for the intended purpose. As a result of utilizing the extraction container 100, a user may have been able to easily prepare, extract, store (including for prolonged periods), and dispense the vanillin extract with a single or a few items of equipment that may be relatively low cost and simple to use and clean.

It will also be recognized that the extraction using the extraction container 100A may occur from other biological matter such as meat or animal products. The extraction may further occur from dirt, soil, rock and/or minerals.

It will also be recognized that the extraction container 100 may be of many sizes. For example, in one or more embodiments, the extraction container may be five-gallons in size for use in laboratory or commercial settings. In one or more other embodiments, the extraction container 100 may be a small pouch that is pocked-sized for personal use or for extraction small amounts of compound 201.

Although the present embodiments have been described with reference to specific example embodiments, it will be evident that various modifications and changes may be made to these embodiments without departing from the broader spirit and scope of the various embodiments.

In addition, the process flows described or logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

Embodiments of the invention are discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Unless defined otherwise, all technical, engineering, and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems.

Features which are described in the context of separate embodiments may also be provided in combination in a single embodiment. Conversely, various features which are, for brevity, described in the context of a single embodiment, may also be provided separately or in any suitable sub-combination. The applicants hereby give notice that new claims may be formulated to such features and/or combinations of such features during the prosecution of the present application or of any further application derived therefrom.

References to “one embodiment,” “an embodiment,” “example embodiment,” “various embodiments,” “one or more embodiments,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least one or more embodiments of the invention” includes the stated particular feature, structure, or characteristic.

The enumerated listing of items does not imply that any or all of the items are mutually exclusive, unless expressly specified otherwise.

It is understood that the use of a specific component, device and/or parameter names are for example only and not meant to imply any limitations on the invention. The invention may thus be implemented with different nomenclature and/or terminology utilized to describe the mechanisms, units, structures, components, devices, parameters and/or elements herein, without limitation. Each term utilized herein is to be given its broadest interpretation given the context in which that term is utilized.

A description of an embodiment with several components in physical communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Any abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An extraction container for extracting a chemical compound with a solvent from a plant matter, the extraction container comprising:
a base comprised of a flexible polymer and flat such that the extraction container can rest upright during an extraction when the base is placed on a surface;
one or more walls comprised of the flexible polymer coupled to the base and forming both an interior of the extraction container for holding the plant matter and an opening at the top of the extraction container,
wherein the flexible polymer permits a user to knead the plant matter within the extraction container;
a fastening mechanism configured to at least one of (i) fasten the opening in a closed position and (ii) fasten a lid to the opening;
a port coupled to at least one of the lid and the one or more walls enabling elevated pressure of a gas inside the extraction container relative to an exterior environment of the extraction container to vent to the exterior environment; and
a strainer spanning a portion of the one or more walls such that the chemical compound and the solvent can be separated from the plant matter with the extraction container following the extraction.

2. The extraction container of claim 1, wherein the flexible polymer is at least one of a silicone material and a polypropylene that can be heated in at least one of an oven, a toaster oven, a conventional oven, and a microwave oven.

3. The extraction container of claim 1, wherein the strainer is made of the flexible polymer.

4. The extraction container of claim 1, wherein:
the base is ovoid,
the one or more walls comprise a first wall and a second wall extending up from two sides of the ovoid, such that the first wall and the second wall become adjacent when the extraction container is flattened for storage,
the fastening mechanism comprises a locking track along the opening, and
the strainer spans a portion of the first wall and a portion of the second wall and folds when the extraction container is flattened for storage.

5. The extraction container of claim 1, wherein the extraction container and the flexible polymer can withstand a temperature of at least 250 degrees Fahrenheit and the fastening mechanism can withstand an internal pressure differential of 2 atm.

6. The extraction container of claim 1, wherein at least one of the one or more walls comprises at least one of a fill mark for the plant matter and a fill mark for the solvent.

7. The extraction container of claim 1, wherein the port comprises a one-way pressure release configured to only permit the gas to be expelled from the interior of the extraction container to the exterior environment of the extraction container.

8. The extraction container of claim 1, wherein the fastening mechanism forms an airtight seal.

9. The extraction container of claim 1, further comprising:
a filter receiver at least one of integrated in the port, coupled to the port, and spanning a different portion of the one or more walls, the filter receiver configured to receive
a filter for filtration of the solvent to remove the plant matter,
wherein the filter is at least one of a silk mesh, a grease screen, and a stainless steel mesh.

10. The extraction container of claim 1, further comprising:
an odor filter coupled to the port to reduce odors expelled from the interior of the extraction container during venting; and
a variable pressure release configured to adjust a venting pressure at which an elevated pressure of the gas inside the extraction container vents to the exterior environment.

11. A method for extracting a chemical compound from a plant matter, the method comprising:
placing the plant matter inside an extraction container, wherein the extraction container comprises
a base that is flat such that the extraction container can rest upright on a surface during an extraction;
one or more walls comprised of a flexible polymer coupled to the base and forming both an interior of the extraction container for holding the plant matter and an opening at the top of the extraction container,
a fastening mechanism enabling air-tight fastening of the opening,
a strainer coupled to and spanning a portion of the one or more walls;
adding a solvent to the inside of the extraction container at a first temperature;
closing a fastening mechanism of the extraction container;
heating the extraction container past a second temperature that is higher than the first temperature for a period of time to extract the chemical compound from the plant matter;
cooling the extraction container below the second temperature; and
decanting the solvent carrying the chemical compound out of the extraction container and through the strainer to result in a rapid, single-tool extraction process for the chemical compound.

12. The method of claim 11, further comprising:
kneading the plant matter within the extraction container through the flexible polymer to at least one of reduce processing tools, reduce process steps, and reduce cleanup.

13. The method of claim 11, wherein the extraction container further comprising a port configured to vent elevated pressure inside the extraction container relative to an exterior environment of the extraction container to the exterior environment at one of at least two variable pressure settings, the method further comprising:
adjusting a variable pressure setting to determine a venting pressure, and
venting the extraction container through the port.

14. The method of claim 11, wherein the extraction container further comprising a filter receiver spanning a different portion of the one or more walls and configured to receive a filter, the method further comprising:
placing the filter in the filter receiver,
wherein the filter is at least one of a silk mesh, a grease screen, and a stainless steel mesh.

15. The method of claim 11,
wherein a port of the extraction container coupled to an odor filter to reduce odors expelled from the interior of the extraction container during venting, and
wherein the extraction container is heated in at least one of a conventional oven and toaster oven.

16. The method of claim 11, wherein the plant matter comprises a cannabis plant and the solvent comprises at least one of a fat, an oil, and an alcohol.

17. The method of claim 11, wherein:
the base is ovoid,
the one or more walls comprises a first wall and a second wall extending up from two sides of the ovoid, such that the first wall and the second wall become adjacent when the extraction container is flattened for storage,
the fastening mechanism is a locking track along the opening, and
the strainer spans the first wall and the second wall and folds when the extraction container is flattened for storage.

18. An extraction bag comprising:
a base comprised of a flexible polymer and flat such that the extraction bag can rest upright during an extraction when the extraction bag is filled with a solvent and a plant matter and the base is placed on a surface;
one or more walls comprised of the flexible polymer coupled to the base and forming both an interior of the extraction bag for holding the plant matter and the solvent, and an opening at the top of the extraction bag,
a fastening mechanism configured to fasten the opening in a closed position;
a port coupled to the one or more walls enabling gas inside the extraction bag to vent to an exterior environment; and
a strainer comprised of the flexible polymer and spanning a portion of the one or more walls such that a solution comprising the solvent and a chemical compound extracted from the plant matter can be separated from the plant matter with the extraction bag following the extraction.

19. The extraction bag of claim 18, wherein:
the base is ovoid,
the one or more walls comprise a first wall and a second wall extending up from two sides of the ovoid, such that the first wall and the second wall become adjacent when the extraction bag is flattened for storage,
the fastening mechanism comprises a locking track along the opening, and
the strainer spans a portion of the first wall and a portion of the second wall and folds when the extraction bag is flattened for storage.

20. The extraction bag of claim 18, wherein:
the flexible polymer is at least one of a silicone material and a polypropylene that can be heated in at least one of an oven, a toaster oven, a convention oven, and a microwave oven,
the flexible polymer permits a user to knead the plant matter within the extraction bag,
the extraction bag and the flexible polymer can withstand a temperature of at least 250 degrees Fahrenheit and the fastening mechanism can withstand an internal pressure differential of 2 atm, and
the fastening mechanism forms an airtight seal.
